(19) United States
(12) Patent Application Publication
(10) Pub. No.: US 2017/0046900 A1
(43) Pub. Date: Feb. 16, 2017

(54) PRINTING DEVICE WITH CLOSABLE PRESENTING WINDOW AND METHOD FOR OPERATING OF SUCH DEVICE

(71) Applicant: APS Trading Ood, Botevgrad (BG)

(72) Inventor: Denis Montagutelli, Angers (FR)

(21) Appl. No.: 15/305,724

(22) PCT Filed: Apr. 23, 2015
(86) PCT No.: PCT/EP2015/058860

§ 371 Date: Oct. 21, 2016

(30) Foreign Application Priority Data
Apr. 25, 2014 (EP) 14165959.9

(51) Int. Cl. G07C 13/00; B41J 29/02; B41J 2/32

(52) U.S. Cl. CPC G07C 13/00; B41J 2/32; B41J 29/02

(57) ABSTRACT

The present disclosure relates to a printing device with closable presenting window and to a method for operating. The printing device comprises a printing unit, an external lid with a presenting window for observing of a printed part of the paper, means for aligning the printed part of the paper to the presenting window, a control unit, and a shutter positioned below the presenting window. The shutter can be controlled by the control unit and can be a liquid crystal electronic shutter having maximum opacity when no voltage is applied to it.

The method comprises: determining if the presenting window is closed and closing the window if open; receiving data from a user; printing the data and positioning the printout below the closed presenting window; opening the presenting window to display the printout; closing the presenting window in response to user confirmation; and preparing to receive subsequent data.

### CROSS-REFERENCE TO RELATED APPLICATIONS

This application claims priority under 35 U.S.C. 371 to PCT/EP2015/058860, filed on Apr. 23, 2015, which in turn claims priority to European Patent Application Serial No. 14165959.9, filed on Apr. 25, 2014. The contents of each of these applications is incorporated by reference in their entirety for all purposes.

### TECHNICAL FIELD OF THE INVENTION

The present disclosure relates to a printing device with printout presenting window and to a method for operating of such device.

### PRIOR ART

In several fields data needs to be printed and presented to be read and eventually validated by a physical person, but kept physically not accessible to any person, to avoid data to be modified or destroyed.

In many cases, such data have to be stored after having been validated by the reader. Such storage can be done in a kind of storage box. In this case, each printed record corresponds to a single strip of paper.

Such printing devices are used, for instance, in gaining or banking applications, but also for voting application where the voter has to check the ballot which has been printed after its voting choice. Then the printed ballot, which is a single paper strip is conveyed to a ballot box.

Such applications are described in documents such as EP1 477 939, EP 1 842 682, or application EP13157369.3-A. In this last application, the printed record has to be seen by a single and no other person at a time, the voter. This constraint dictates the way the paper is mechanically processed and how it is physically presented under the presenting window.

Since the printed record is in most of the cases coming from a single paper roll, the paper is cut into one strip per record, and the process is to first print the record, present it under the presenting window and cut it, or vice-versa according to the mechanical configuration and the distance from the printing device to the presenting window, and after the reader has checked it, transport it into a storage box, which is a mechanically complex process, not easy to make reliable, and will take a lot of space to store afterwards, and practically impossible to scan or in some way electronically backup, due to the fact the whole printed records consists in a very large number of paper strips which at the end are plied, compressed, in any direction, in the storage box.

Another way is to print the record one after the other on a continuous paper strip continuously coming from a paper roll, and then rewind this paper strip after such record has been validated and or checked by a physical person. Then all printouts stand one behind the other on a single rewinded paper strip.

In such embodiment, the advantage is to simplify the paper transport, to improve the total process reliability, but in this case, for each record, the process is to print the record, present it under the reading transparent window, and after it has been checked, rewind it, in order to hide it to the next reader, thus presenting a blank piece of paper to the next person. The disadvantage of this process is that for each record, there is a blank record with the size of the presenting window to be generated, thus requiring twice as much paper as needed per record.

In both cases, the reader will see the paper record being printed out, and slowly appearing under the presenting window, while progressively hiding the mechanical ballot transport system in action, instead of presenting the printing record at the end of the printing process and in one shot as if it were shown on a display. This may disturb the reader's concentration.

### SUMMARY OF EXEMPLARY EMBODIMENTS

One particular aim of embodiments disclosed herein is to separate the printing process, and the printed record transport process from the reading process through the presenting window.

In order to achieve this aim the present disclosure proposes a printing device with closable presenting window. In this connection a shutter is placed between the printed record and the physical person who has to read the printed record, at the position of the presenting window, in order to allow or not the reading of the record by the physical person.

A particular object of the present disclosure is to provide a voting apparatus comprising printing device with closable presenting window.

Another object of the present disclosure is to provide a method for operating of a printing device with closable presenting window.

Embodiments of the printing device disclosed herein comprise a printing unit, an external lid with a printed paper presenting window, arranged above an internal route of printed paper after the printing unit, so as a printed part of paper to be observable through said printed paper presenting window, a means for aligning of said printed part of the paper to said printed paper presenting window and a control unit. The printing device further comprises a shutter controlled by the control unit and positioned under said printed paper presenting window, said shutter being designed so as to close and open said printed paper presenting window.

In some exemplary embodiments, the printing unit is a direct thermal printer.

In some exemplary embodiments, the shutter is an electronic shutter. In some exemplary embodiments, the electronic shutter is a liquid crystal shutter, adapted to have maximum opacity in absence of voltage applied to it.

In some exemplary embodiments, the printing device further comprises a protective transparent plate covering the area of the printed paper presenting window and arranged above the shutter.

In some exemplary embodiments, the printing device further comprises an optical sensor for sensing the opacity of the shutter.

In some exemplary embodiments, the printing device further comprises a lighting unit positioned between the shutter and the internal route of the printed paper to be observed. In some exemplary embodiments, the lighting unit comprises plurality of LEDs arranged at perimeter of the printed paper presenting window.

In some exemplary embodiments, the printing device further comprises a light sensor for measuring of light illumination level in a section of the lighting unit.

In some exemplary embodiments, the aligning means comprises an aligning shaft positioned at an end of the shutter that is opposite to the printing unit.

In some exemplary embodiments, the printing device further comprises a rewinding shaft for rewinding of printed paper comprising a continuous paper tape, said rewinding shaft being positioned downstream to the shutter.

In some exemplary embodiments, a voting apparatus comprises a printing device according to the present disclosure.

Method according to the present disclosure for operating of a printing device, the printing device comprising a printing unit, an external lid with a closable presenting window for observing of a printed part of paper, a control unit and a data imputing means, said method comprising a repeatable printing cycle with steps comprising:
checking by said control unit if said closable presenting window of the external lid is closed and closing said closable presenting window if not closed;
receiving data to be printed;
printing by said printing unit of the received data on paper and simultaneously transferring of respective printed part of the paper under area of the closed closable presenting window;
opening of the closable presenting window after finishing of the printing process to display said printed part of the paper through said closable presenting window;
awaiting for a validation instruction and after receiving of said validation instruction closing the closable presenting window;
checking by the control unit if said closable presenting window is closed before receiving next data for next printing session.

In some exemplary embodiments, the printed part of the paper remains below the closed closable presenting window till the start of next print session and during the next print session the printed part of the paper from the previous printing session is forwarded and stored in a secured part in the printing device.

In some exemplary embodiments, said printing device comprises a shutter arranged below the closable presenting window of the external lid for opening and closing of said closable presenting window, said shutter being controlled by the control unit of the printing device.

One important advantage of embodiments of the present disclosure is to reduce the paper length required for printing a set of records to be seen successively by several different users in a confidential way, as it will now be described.

In particular, in the voting systems, the voters have to validate a printed ballot corresponding to the printout. Voting systems incorporating embodiments disclosed herein avoid the length of blank paper record thus doubling the number of ballots able to be printed on a paper roll.

Embodiments of the present disclosure allow to double the number of ballots printed on a paper roll, when the ballots are rewinded, bringing a major advantage to this way of storing the ballots, simplifying the printing function since no paper cutter nor transport is required, and optimizing the media size since no paper is lost.

### BRIEF DESCRIPTION OF THE DRAWINGS

The characteristics of various embodiments will be disclosed in details in the following description of preferred embodiments, given as a non-restrictive example, with reference to the attached drawings wherein:

FIG. 1 is an exploded view of the printed record presenting system according to one or more embodiments of the present disclosure;

FIG. 2 illustrates an embodiment wherein a rewinding system is positioned downstream to the shutter.

### DETAILED DESCRIPTION OF EXEMPLARY EMBODIMENTS

The terms “above” and “under” in the present description and claims are relative and should not be interpreted as limiting the scope but as describing mutual arrangement of the elements of the exemplified embodiment of invention as shown on the figures. For the persons skilled in the art it will be clear that printing device can be positioned in a different way in the space and the respective mutual position of the elements could be no longer described by the terms “above” and “under”.

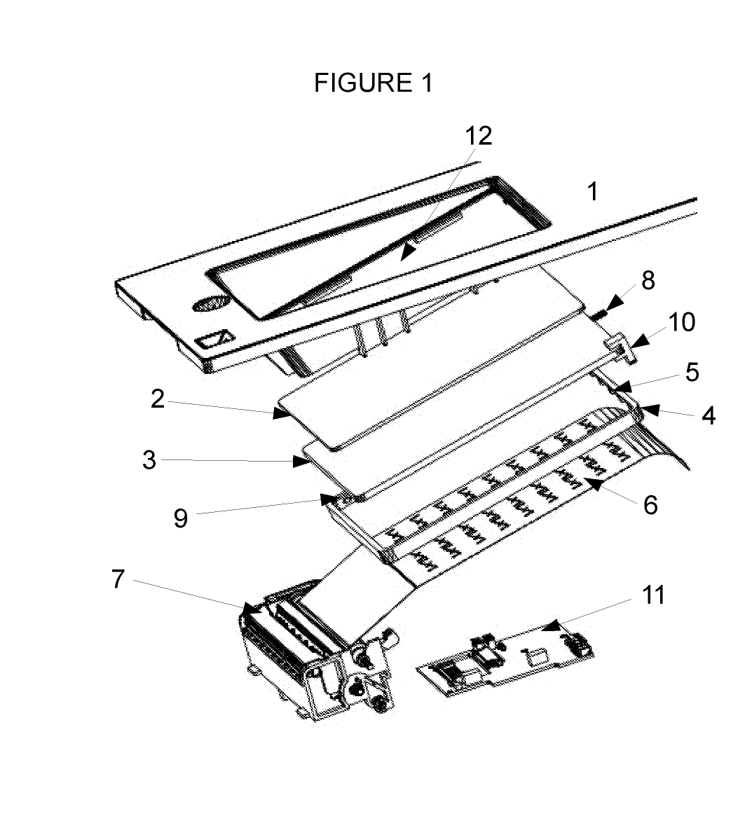

FIG. 1 is an exploded view of printed record presenting system of printing device according to one or more embodiments of the present disclosure. The printing device comprises an external lid 1, wherein a printed paper presenting window 12 for presenting of a printed part of paper 6 is arranged, driving means and means for aligning of the printed part of paper 6 to the printed paper presenting window 12 (not shown on FIG. 1), control unit 11 and a printing unit 7. Preferably a protective transparent plate 2 is inseparably mounted on the lid and covers the printed paper presenting window area, to isolate the inner part of the device from any external stress. Additionally said protective transparent plate 2 secures the device from unauthorised access through the printed paper presenting window 12. Advantageously, the protective transparent plate 2 is a plastic glass plate.

Different systems to align the printed part of paper 6 along the printed paper presenting window 12 can be used, like motorized transportation belts or simple flat paper guide covering the printed paper presenting window 12 area, said systems being located right under internal route of the printed paper in the printing device.

Further, in order to provide a possibility to close the printed paper presenting window 12, a shutter 3 is positioned under the presenting window 12 between the protective transparent plate 2 and the internal route of the printed paper.

In one embodiment said shutter 3 is a mechanical shutter, for example a blade or a leaf shutter, which can be very thin, or any other type of mechanical shutter.

In such arrangement, an additional lighting system for the printout can be avoided, since the mechanical shutter is fully transparent when open.

In an exemplary embodiment shown in FIG. 1, the shutter 3 is an electronic shutter. Using electronic shutter allows avoiding any moving parts, making it very reliable and cost effective. Advantageously, the shutter 3 is based on a liquid crystal technology, being a single rectangle of liquid crystal, electronically controlled by a control unit 11 through two connecting wires 8. Advantageously, when no voltage is applied to the shutter, the light transmittance is at its lowest level, to secure the confidentiality in case of power down.

Advantageously, the device also comprises an optical sensor 10 for sensing the shutter 3 transparency and/or opacity, in order to physically make sure that the shutter transparency value is correct at any time. Preferably said optical sensor 10 is a fork photosensor. Said optical sensor 10 is also connected to the control unit 11.

Advantageously in order to increase the printed part of paper 6 readability and, since the liquid crystal shutter transparency is not very high when it is powered, a lighting unit 4 is arranged between the shutter 3 and the internal route of the printed paper. Said lighting unit 4 is activated when the power is applied to the shutter 3, in order to improve the printout readability. Since the distance between the shutter 3 and the printed part of paper 6 has to be kept small in order to make sure that the printout will not be readable at any angle of view, this lighting unit 4 needs to have a low profile.

Such lighting unit can use incandescent lighting or any known lighting means.

Advantageously, said lighting unit 4 comprises a plurality of LEDs 5, mounted around perimeter of the printed part of paper 6 to be red, providing a low mechanical profile, powerful light and a long life.

Advantageously, a light sensor 9, preferably photosensor, is mounted on the perimeter of the lighting unit 4 and connected to the control unit 11 in order to measure the LED illumination and make sure that the state of the light is correct at any time.

Advantageously the printing unit 7 is a thermal printer.

The source paper (not shown on FIG. 1) can be a preliminary cut paper, a paper roll or any other kind of a continuous paper tape.

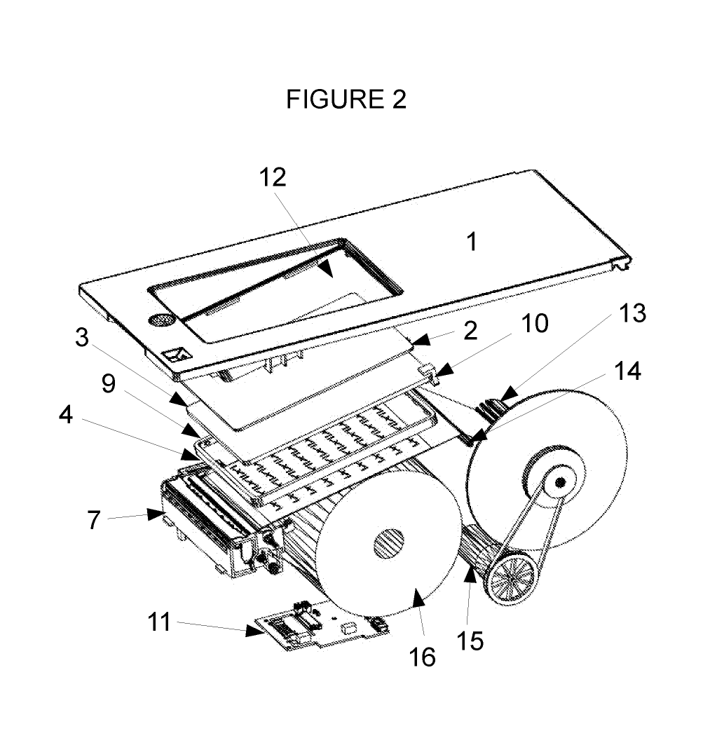

FIG. 2 shows an additional embodiment, wherein a paper rewinding system is positioned downstream to the shutter 3 and the printout is printed by the printing unit 7 on a continuous paper tape from a paper roll 16. Such rewinding system can comprise a rewinding wheel with a rewinding shaft 13 and a rewinding motor 15.

Since the paper is rewound around the rewinding shaft 13, the diameter of a paper roll around the rewinding shaft 13 will increase when more and more paper is rewound.

In order to keep the printed part of paper 6 parallel to the shutter 3, an aligning shaft 14 is positioned at the end of the shutter 3 that is opposite to the printing unit 7. Since the paper is put into tension by the rewinding system and because the aligning shaft 14 will keep the distance between the printed part of paper 6 and the shutter 3 always constant whatever is the diameter of the paper roll around the rewinding shaft 13, the aligning shaft 14 is sufficient to align the printed part of paper 6 to the printed paper presenting window 12.

Further, data imputing means, such as keyboard (not shown on the figures) for entering of instructions from a user can be arranged on the lid 1. Other peripherals like an LCD display can be installed to ease the interface with the user, up to turn for instance the printer into a standalone voting machine. Alternatively the printer can be only a peripheral connected through a communication interface to a main device, which handles the interface with the user.

In the embodiments shown in the figures, the control unit 11 receives instructions from users, via a communication interface or directly from a keyboard installed on the printer, receives signals from the photosensors 10 and 9, drives the printing unit 7, and controls the opening and closing of the shutter 3.

Embodiments of the printing device according to the present disclosure can be suitable for a voting apparatus.

Exemplary embodiments of methods for operating of a printing device with a closable presenting window comprise the following steps: checking if the presenting window is closed; receiving an instruction from a user; printing of printout according to the instruction of the user and simultaneously forwarding the printout below the closed presenting window; opening of the presenting window for displaying of the printout to the user; receiving validation instruction from the user and closing the presenting window; preparing for receiving a next instruction from the same or different user.

In case of voting apparatus comprising a printing device with closable presenting window the voting process is modified as follows:

When a voter enters the voting booth, the shutter 3 of the printing device is closed. The control unit 11 by the fork photosensor 10 is checking accordingly the transparency of the shutter 3 and by the photosensor 9 is checking if the lighting unit is off.

Such photosensor 9 can also check at any time that no parasitic light is present in the lighting unit 4, in case someone would like to try to illuminate the printed record with an external very powerful light source.

Then the voter selects the candidate he wants to vote for and enters corresponding data via data input means of the voting apparatus. The printing unit 7 prints the corresponding data for the ballot (e.g., on the printed part of paper 6). During this printing operation, the previous ballot is rewound, and the new ballot is printed right after the previous one (if any), without any blank area in between.

After the new ballot has been printed and simultaneously transported under the printed paper presenting window 12, the control unit 11 opens the shutter 3. Simultaneously the control unit 11 activates the lighting unit 4 to illuminate the new ballot, being the next printed part of paper 6. Both sensors 10 and 9 are checked accordingly.

One advantage of this method is also to present the ballot to the voter when it is fully printed, avoiding disturbing the voter with the printing process, while looking the ballot being printed.

Then the voting system asks the voter to confirm his choice, and after the confirmation is done, the shutter 3 is closed and the lighting unit 4 is turned also to off state, and the sensors 9 and 10 are checked accordingly.

If the voter does not confirm his choice an invalidation message is printed out after the ballot to signify that the ballot is not valid, and the process can start again with the same voter.

After the voter exits the voting booth, the next voter can enter the voting booth and the process repeats again.

Embodiments of the printing device disclosed herein can be used in many other applications such as banking systems or gaining apparatus.

Various modifications and/or additions of parts will be apparent to those skilled in the art that will remain within the field and scope of the present disclosure including the appended claims. All the parts may further be replaced with other technically equivalent elements.

1.-15. (canceled)

16. A printing device comprising:
a printing unit;
an external lid comprising a printed paper presenting window arranged such that printed paper output by the printing unit is observable through the printed paper presenting window;
a means for aligning the printed paper to said printed paper presenting window; and
a control unit configured to control a shutter, wherein said shutter is positioned under said printed paper presenting window and is configured to close and open said printed paper presenting window.

17. The printing device of claim 16, wherein the printing unit is a direct thermal printer.

18. The printing device of claim 16, wherein the shutter is an electronic shutter.

19. The printing device according to claim 18, wherein said electronic shutter is a liquid crystal shutter adapted to have maximum opacity in absence of applied voltage.

20. The printing device of claim 16, further comprising a protective transparent plate covering the area of the printed paper presenting window and arranged above the shutter.

21. The printing device of claim 16, further comprising an optical sensor configured to sense the opacity of the shutter.

22. The printing device of claim 16, further comprising a lighting unit positioned between the shutter and the internal route of the printed paper to be observed.

23. The printing device of claim 22, wherein the lighting unit comprises plurality of LEDs arranged at a perimeter of the printed paper presenting window.

24. The printing device of claim 22, further comprising a light sensor configured to measure light illumination level in a section of the lighting unit.

25. The printing device of claim 16, wherein said aligning means comprises an aligning shaft positioned adjacent at an end of the shutter that is opposite to the printing unit.

26. The printing device of claim 16, wherein:
the printed paper comprises a portion of a continuous paper tape; and
the printing device further comprises a rewinding shaft for rewinding of the continuous paper tape, said rewinding shaft being positioned downstream to the shutter.

27. The printing device of claim 26, wherein the rewinding shaft is located in a secure part of the printing device.

28. The printing device of claim 16, wherein the printing device is configured to be operable as a voting machine.

29. A method for repetitive operating of a printing device comprising a printing unit, an external lid with a presenting window for printed data, a control unit, and a data input unit, said method comprising:
determining, by said control unit, if said presenting window is closed and closing said presenting window if not closed;
receiving first data to be printed during a first printing session;
printing the first data on a first portion of paper and subsequently positioning the first portion of paper under the presenting window;
opening the presenting window to display the printed first data;
closing the presenting window in response to receiving a confirmation instruction; and
determining, by the control unit, if said presenting window is closed before receiving second data to be printed during a second printing session.

30. The method of claim 29, further comprising maintaining the position of the first portion of paper under the closed presenting window until the second printing session.

31. The method of claim 29, further comprising, during the second printing session, forwarding and storing the first portion of paper in a secured part of the printing device.

32. The method of claim 29, further comprising printing an invalidation message on a second portion of paper in response to receiving a non-confirmation instruction.

33. The method of claim 29, wherein the opening and closing of said presenting window is performed by the control unit via a shutter arranged below the presenting window.
